(19) United States
(12) Patent Application Publication
(10) Pub. No.: US 2026/0149571 A1
(43) Pub. Date: May 28, 2026

(54) CRYPTOGRAPHICALLY SECURE INFERENCING SYSTEM

(71) Applicant: Amazon Technologies, Inc., Reno, NV (US)

(72) Inventors: Saurabh Mukund Trikande, Bothell, WA (US); Wenzhao Sun, Kirkland, WA (US)

(21) Appl. No.: 18/963,360

(22) Filed: Nov. 27, 2024

(51) Int. Cl. H04L 9/08

(52) U.S. Cl. CPC H04L 9/0825

(57) ABSTRACT

Approaches are disclosed for providing optimized AI models for use in performing various inferencing tasks. In at least one embodiment, a user may request a model to be used to perform an inferencing task, and may be presented with one or more optimization options. The user can select one or more of these optimization options, and in response a model and parameter set can be provided to the user, where the model and/or parameter set may be optimized and/or proprietary, and thus have their use restricted. Such an approach allows a user to effectively obtain a customized AI model that can be used for a specific type of inferencing task without the need to fine-tune or customize the model. In order to protect any intellectual property (IP), such as an optimized parameter set offered by a provider, the set may be encrypted and able to be decrypted and used only in authorized environments and associated with users having a valid key or cryptographic token associated with the set of optimized parameters.

A rapidly increasing number of users are turning to artificial intelligence (AI) to perform inferencing for a wide variety of tasks. In many instances, users will not have sufficient knowledge or experience to properly select, train, and fine-tune an AI model for a specific domain or purpose. Further, users will often lack the significant resource capacity needed to train and host models that may include billions of parameters or more. In many instances, users will turn to model providers to provide trained and potentially optimized models, as well as to resource providers to host instances of those models in secure environments so that important customer data is not exposed. Problems arise in that the most advanced artificial intelligence (AI) models represent closely guarded intellectual property of various model providers, who can be hesitant to distribute these valuable assets as they risk unauthorized access and potential misuse of the underlying technology. There is also a growing need to optimize the performance and efficiency of AI models without compromising their accuracy for real-world applications, but model providers can also be hesitant to openly share such enhancements.

### BRIEF DESCRIPTION OF THE DRAWINGS

Various embodiments in accordance with the present disclosure will be described with reference to the drawings, in which:

FIG. 1 illustrates an example system that can be used to provide models for performing inferencing tasks, in accordance with various embodiments.

FIG. 2 illustrates components of an example system in which different parameter sets may be provided for use with different users or in different environments, in accordance with various embodiments.

FIG. 3 illustrates an example system that allows a user to customize a secure set of optimized parameters without the user gaining access to the optimized parameters, in accordance with various embodiments.

FIG. 4 illustrates an example process that can be performed to automatically identify and deploy an optimized model to perform an inferencing task, in accordance with various embodiments.

FIG. 5 illustrates an example process that can be performed to monitor usage of an AI model and automatically provide one or more optimizations, in accordance with various embodiments.

FIG. 6 illustrates an example process that can be performed to secure access to an optimized parameter set, in accordance with various embodiments.

FIG. 7 illustrates an example process that can be performed to dynamically determine which model and parameter set to use to perform an inferencing task, in accordance with various embodiments.

FIG. 8 illustrates a network-inclusive computing environment in which aspects of various embodiments can be implemented.

FIG. 9 illustrates example components of a server that can be utilized to perform at least a portion of a content encoding process, in accordance with various embodiments.

FIG. 10 illustrates example components of a computing device that can be used to implement content encoding and transmission aspects of various embodiments.

### DETAILED DESCRIPTION

Approaches described and suggested herein relate to the performance of inferencing operations using artificial intelligence. In particular, approaches in accordance with various embodiments allow a user (or other authorized entity) to receive an optimized model and/or optimized parameter set for a type of inferencing task, such that the user is able to perform inferencing using a customized model without having to perform any training or fine-tuning of their own. Further, at least some embodiments allow for the public distribution of machine learning (ML) models and/or parameter sets, while restricting access to optimized or proprietary models or parameter sets to those users having the appropriate cryptographic material (e.g., a private key or “decryption” key) to decrypt the parameters for use within an authorized inferencing environment.

In at least one embodiment, an artificial intelligence-based inferencing system or service can allow for the secure distribution and utilization of proprietary artificial intelligence (Al) models. There may be default parameters and optimized parameters available for use, where any user may be allowed to use the default parameters with a model to perform inferencing. A set of optimized model weights or parameters, as may have been generated by training or fine-tuning the model on a proprietary data set, can be encrypted so the set can be shared publicly, while only allowing authorized parties to access and decrypt the models and/or parameters for performing inferencing operations. Many of the most advanced AI models are the closely guarded intellectual property of leading technology companies, research labs, and AI providers, such as Anthropic, Meta, Cohere, and others. Model providers are often hesitant to widely distribute their valuable assets, as they risk unauthorized access and potential misuse of the underlying technology. Approaches in accordance with various embodiments provide the ability to securely run proprietary AI models using optimized or proprietary network weights or parameters. Such approaches allow model providers to upload their encrypted model weights to, for example, a central, trusted service, system, or platform. Users and deployment environments can then request access to use the models, but the central, trusted service (or model provider, etc.) will only grant decryption keys to verified, authorized users or entities that have an account, or other relationship or agreement, with the model provider. Such approaches can effectively decouple the distribution of models from the control over the intellectual property (IP). Model providers can make their technology broadly available, knowing that only approved parties can actually utilize the models. Users, meanwhile, can access cutting-edge Al capabilities without having to replicate the full model training process. Such an approach also allows for further fine-tuning and customization of proprietary AI models using the user-specific data, such as a training data set generated or curated by that user as may include user-specific or private data. The encrypted weights can be downloaded, adjusted, and then re-uploaded, all while the model provider maintains oversight and protection of their core IP. Bridging needs of both model providers and model consumers can unlock new possibilities for the democratization of advanced AI technologies across a wide range of industries and applications.

Approaches in accordance with at least one embodiment can also provide a secure cryptographic mechanism to protect proprietary inference optimizations and other such features or aspects in AI models. As AI continues to advance, there is a growing need to optimize the performance and efficiency of AI models without compromising their accuracy for real-world applications. Popular optimization techniques such as quantization, distillation, model loading, and model sharding can unlock significant price-performance gains, but the development of these enhancements often requires significant proprietary work that organizations are understandably hesitant to share openly. Approaches disclosed herein can take advantage of a robust inference environment with stringent access controls and encryption. AI models, whether open source or proprietary, can be hosted within this secure environment, where the environment may have to have been authorized by a model provider to support and allow use of their proprietary models and parameters. Users and/or applications can then submit inference requests, which can be executed only within a protected, authorized environment. The model parameters, training data, and other sensitive information can be prevented from leaving this secure system, ensuring the intellectual property of the model owners is safeguarded.

A cryptographic system, service, or server can further incorporate an optimization module that can autonomously analyze hosted AI models to attempt to identify opportunities for improving key performance characteristics. This can include, for example, optimizing for characteristics such as speed, efficiency, and robustness, while preserving the accuracy of the model. An optimization module can apply techniques such as quantization, distillation, model loading, and model sharding to fine-tune or restructure the models accordingly. This optimization work can be performed entirely within a secure environment, without any replication or exposure of the model details. A cryptographic protocol can be used that allows for the packaging and distribution of these or other such proprietary optimizations. Optimized models in at least one embodiment can be shared as containerized artifacts that can only be executed within an authorized inference environment. This helps to ensure that the commercial value and integrity of the optimization work is preserved, while still allowing widespread adoption and deployment. Such a secure cryptographic approach can help to unlock the benefits of advanced, accurate AI capabilities by, in part, empowering optimization providers to innovate and profit from their work, without compromising the intellectual property. By facilitating this secure, controlled ecosystem, such an approach can accelerate the real-world impact of state-of-the-art machine learning across industries. Such an approach also helps to bridge the gap between AI research and commercial-grade deployments, enabling proprietary optimizations that enhance efficiency and performance without sacrificing model accuracy or exposing sensitive details.

In the following description, various embodiments will be described. For purposes of explanation, specific configurations and details are set forth in order to provide a thorough understanding of the embodiments. However, it will also be apparent to one skilled in the art that the embodiments can be practiced without the specific details. Furthermore, well-known features can be omitted or simplified in order not to obscure the embodiment being described.

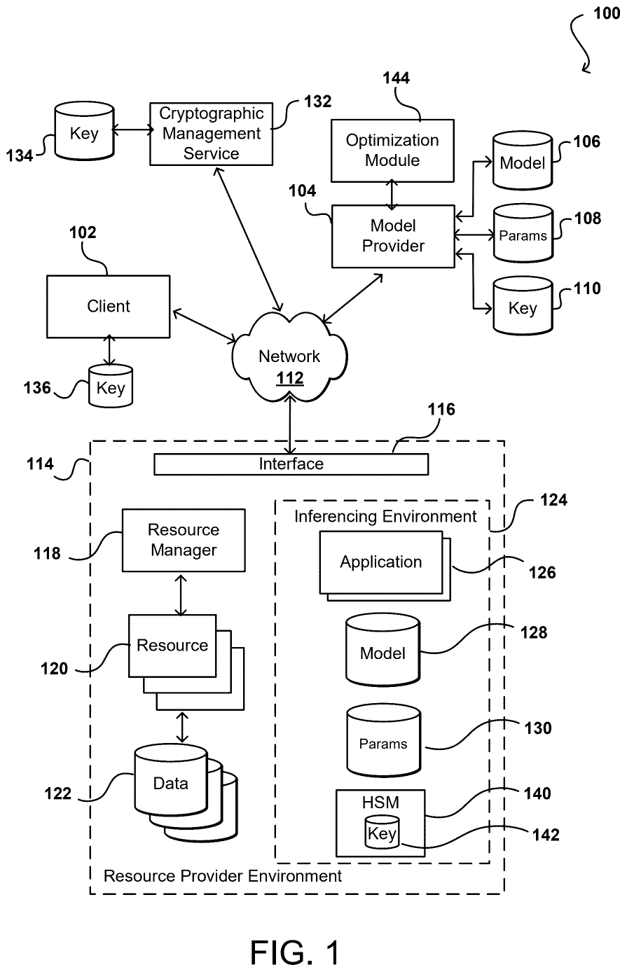

FIG. 1 illustrates an example environment 100 in which aspects of the various embodiments can be implemented. In this example, a user has requested to obtain an artificial intelligence (AI) model (or machine learning (ML) model or artificial neural network (ANN), etc.) from a model provider system 104 (e.g., Anthropic). In this example, the user can use a client device 102 to submit a request across at least one network 112, such as the Internet or a cellular network, that can be received by a model provider system 104 (or service, etc.). In this example, the model (once obtained) will be hosted in a resource provider environment 114, such that in some embodiments the user may instead use a client device 102 to submit a request to the resource provider environment 114. This can then cause the model to be obtained from the model provider system 104, among other such options. The model provider system 104 can provide a model 128 from a model repository 106, for example, which can then be transmitted for use within an inferencing environment 124 of the resource provider environment. The model provider system 104 can also provide a set of network parameters 130 (or network weights) that are to be used with the model 128 in the inferencing environment 124. The model parameters 130 can have been determined through training of the model using a specific set of training data, as performed by the model provider system 104. Each node of each layer of the model may have a respective parameter or network weight determined with respect to a local mathematical operation (e.g., a transfer function that combines or processes inputs) during the training process. The model provider system 104 may store multiple sets of parameters in a parameter repository, for example, where different sets of parameters may correspond to training of the same model, or a different model, on a different domain or dataset, or for a different purpose or use case. In some embodiments, there may be different sets of parameters for different sizes or variations of the model, where larger models with larger numbers of parameters may be more accurate or comprehensive but require significantly more resources for training or inferencing, while smaller models may be more lightweight and faster, but may be limited in scope of inferencing or slightly less accurate, etc.

An advantage to having different parameter sets for a given model is that a user requesting use of a model can receive parameters for that model that are more appropriate for a given use or situation. For example, a classifier model may be trained on different domains of data, such as to classify animals, vehicles, or inventory. A classifier may also be trained on all of these different data domains, such that the classifier may recognize objects of any of these domains, although potentially less accurately than if trained for that domain alone. If the user requests a copy of a model from a model provider and specifies a particular domain, the model provider system can select the appropriate model 128 from the model repository, and can also select the appropriate set of parameters 130 from a parameter repository 108 so that the model 128, when available in the inferencing environment for the user and having the domain-specific parameter set applied, will function as a model that is fine-tuned or optimized for that particular data domain. As used herein, an “optimized” model can include any model that was optimized, trained, designed, or otherwise created or provided for a specific purpose or type of task, use with a specific data set or domain, or other such goal. This may include a proprietary model or a model with a set of proprietary model parameters, which may have been designed, trained, or otherwise “optimized” for a particular goal, purpose, business, or domain, etc. In some instances there may not be a “default” model and an optimized model from which a user can select, but only one or the other. If a user does not qualify to use the optimized model then the user may need to identify another model source or provider. Such an approach to optimization and/or customization is advantageous at least in the fact that it allows a user to specify various aspects or intended uses for an ML model, for example, and can receive a model 128 and parameter set 130 that is selected to be optimal (or at least appropriate) for those selections. The user can then effectively have an optimized and/or fine-tuned model available for use instantly, without need to train, optimize, or modify a default model, or need to fine-tune a model that may have been trained and/or optimized for a different or more general data domain.

There may be other optimizations that can be applied instantly as well within the scope of various embodiments. For example, it may be desired to optimize a model for aspects such as minimum cost, maximum accuracy, minimum size, maximum speed, minimum latency, smallest number of parameters, performance on specific hardware, and the like. A model provider system 104 can store various models, as well as different versions of these models, in a model repository 106, where those models may have been optimized for these various optimizations. There may also be corresponding parameter sets for any of these optimizations, where the number and/or values of these parameters may vary. As mentioned, there may be different parameter sets for each optimization as well, such as where the data was trained on a different data domain or for a different type of inferencing operation. In at least one embodiment, a model provider system 104 may include a library of parameter sets, as well as a set of models with different configurations and/or optimizations applied. When a user (or entity or application, etc.) requests use of a model, access to a model, or a copy of a model, the model provider system 104 can use information associated with the request to determine the appropriate optimizations, parameter sets, and other aspects to be provided, and can provide the model and additional content in response to the request. The user can then get a model that is essentially a customized model, without the need to perform any further training, customization, or optimization, except where desired as discussed in more detail elsewhere herein.

In some instances, a model provider may provide a model to a user for use without restriction, other than may be restricted by terms of a license or user agreement. In many instances, however, at least the parameter sets generated by a model provider represent intellectual property of that model provider, which may have significant value. At the very least, the model provider may wish to protect usage and dissemination of those parameters. As known for artificial intelligence, it is often very costly and time-consuming to train a model to generate a valuable parameter set. Further, the quality of the training is dependent upon the quality of the data, including aspects of curation such as selection and labeling. Further, there is often significant data science involved in understanding the training data and knowing how to best select, configure, and train a given model. For at least these reasons, it can be important to attempt to protect against the unintended use or dissemination of these parameters and other related content.

In this example, a parameter set 130 is available for use with a model 128 provided in response to a user request, as may be associated with a user session or user identifying information. To provide for further protection, the parameter set may be restricted from access or use unless that access or use falls within a specific inferencing environment 124. For example, there may be inferencing environments such as SageMaker, from Amazon Web Services, Inc., which allow for the deployment and hosting of models along with inferencing applications 126 and supporting tools. There may be specific inferencing environments for which usage of a set of parameters is approved. The selection of such an inferencing environment can be based upon various factors or functions supported by the inferencing environment 124. For example, the inferencing environment 124 may store the parameters in a secure manner, such that unintended parties are unable to gain access to those parameters. Further, the inferencing environment 124 may store and apply the parameters in such a way that they can be applied to the model 128 in the inferencing environment to perform inferencing operations, or at least a specific type of inferencing operations, but that the actual parameter values are never exposed to even an authorized user. The inferencing environment 124 can also perform tasks such as to ensure only proper usage of the parameter sets, as well as to monitor the usage of those parameter sets for inferencing (or other) operations. Such monitoring can help to ensure that the usage falls within the contractual terms of a usage agreement, such as where a user has obtained up to a certain amount of usage over a given period of time, or in total. Such an environment may also monitor usage of these parameter sets for inferencing operations in order to determine how much to charge the user, as well as to determine usage patterns or rates that may be beneficial in optimizing the resources allocated to perform the inferencing, which can help to improve the efficiency and utilization of the computing system resources. In some embodiments, there may be multiple parameter sets, and certain parameter sets may only be available for use in certain inferencing (or other such) environments. There may be other limitations as well, such as usage only with certain providers, on certain types of resources, under certain security systems or settings, and so on. In at least one embodiment, a user may request a model optimized for a particular domain, but if the model is to be run outside of one of these authorized environments then the user may instead get a default parameter set, or a set of parameters that are appropriate but not optimized for that particular domain, among other such options.

A user may also be able to obtain multiple parameter sets from a model provider (or other such entity or source) that can be used as appropriate. For example, the user might want to use a model 128 for inferencing at different times for different data domains. A user may then be able to obtain multiple different sets of parameters 130 that can be stored in the inferencing environment 124, and then applied to the model 128 for inferencing as appropriate. The user may also have important tasks and less important tasks, and may not want to pay as much to perform the less expensive tasks. The user may then obtain multiple versions of a model 128, as well as parameters sets 130 for those different versions, such that the user can dynamically select use of an optimized model for a particular task, and the inferencing environment 124 can dynamically provide the appropriate model and parameter set, and ensure that the user is billed accordingly.

The resources allocated for the inferencing environment 124 can also depend at least in part upon the size of the model 128 and parameter set 130, as well as the anticipated, projected, or agreed-upon usage. As discussed in more detail elsewhere herein, a resource manager 118 or a resource provider environment 114 can receive a request, as directed by an interface layer 116 of the resource provider environment 114, and can determine the appropriate resources to allocate for the inferencing environment based in part upon the size and anticipated usage. This can include allocation of a type and/or number of resources 120, or resource capacity, where those resources may be physical and/or virtual, as may include compute or networking resources, or databases 122, among other such options. The resource manager 118, an inferencing environment manager (not shown), or other such component or service can configure the resources, install and configure necessary software, and perform other appropriate tasks to support inferencing operations using the obtained model 128 and parameter set 130. As mentioned, this can include security hardware and/or software to securely store the parameter set and prevent unauthorized access, copying, or other such actions.

In some embodiments, it may be desirable to further secure the IP of the model provider, such as specific parameter sets or optimizations. One way to further protect this IP is to apply some type of encryption, or cryptographic protection. This can include, for example, using an asymmetric key pair including a public key and a corresponding private key (or encryption key and decryption key, etc.). For models provided by a model provider, for example, there may be one or more default parameter sets that can be used with the model to perform various inferencing operations. These might include, for example, parameters obtained when training a model on a publicly-available data set. There may be little to no IP in such a parameter set, with the value being the fact that a user does not have to perform the training but can obtain a model trained on publicly-accessible data. A model provider may still require operation in an approved inferencing environment, to at least monitor usage, but may not otherwise protect or secure the parameter set.

It might be the case, however, where the model provider trains a model on a proprietary data set, or data set that includes confidential or proprietary information. It may then be desirable to further protect the parameter set for a number of reasons. For example, there was significant time and expense incurred in generating and curating the data set, in addition to training and any fine-tuning or optimizing, and the model provider does not want another entity to be able to improperly benefit from usage of that IP without at least just compensation, if at all. Further, information learned by the model can be extracted if an entity is able to obtain access to the model and parameters, and it can be important to ensure that such access is prevented to the extent possible.

A model provider can thus determine to encrypt at least some of the parameter sets generated by the model provider through training on specific domains, or data sets, for different inferencing tasks or optimizations, and so on. This may include encryption with an asymmetric key pair 110, as mentioned, where only users having the appropriate private key can decrypt the parameter set. In the example system 100 of FIG. 1, the client device 102 used by the user has access to a local copy of the private key 136, provided by the model provider system 104 from a local key repository 110, and thus can decrypt the respective parameter set. In this example, an instance of the private key 142 is stored in the inferencing environment 124 to allow for decryption within the inferencing environment without need to transmit the key or decrypted parameters outside the inferencing environment 124. It might be the case, however, that multiple users may have access to the same inferencing environment 124. In some instances all of these users may be able to use the optimized model and parameter set, but in other instances only certain authorized users may be able to use the optimized parameter set, while other users are only able to access the model with a default parameter set. In this example, the private key 142 is stored in a hardware security module 140, or other instance of secure hardware, such that the private key is not accessible inside the inferencing environment 124 but external to the HSM 140. This allows the key to be accessible to the authorized user associated with the client device 102 that stores a local instance of the key 136, and can verify that instance, while a user who is not authorized and does not have access to the key will be unable to obtain unauthorized access to the key 142 in the inferencing environment.

In this example, the keys are managed by a third party cryptographic management service 132 that allows for bi-directional exchange. The cryptographic management service 132 can store various keys 134 (or other cryptographic information, such as unique identifiers or digital certificates) for various users or providers, and can generate, provide, and track that cryptographic information to prevent unauthorized access. The cryptographic management service 132 (or a cryptographic server, etc.) can also perform verification tasks, such as to verify that an authorized user has a correct and valid key for a specific operation or use. In some embodiments, the cryptographic management service 132 may be operated by the model provider system 104 or a provider of the resource provider environment 114, such as where a key management service (KMS) provides by Amazon Web Services, Inc. (AWS) is used to manage keys within an AWS environment. A model provider system 104 may request cryptographic data from the cryptographic management service 132, and can use this data to encrypt a given parameter set. An instance of a private key can be provided to the user, or to the inferencing environment 124 or HSM 140 on behalf of a user, which can then decrypt the parameters as appropriate. In some embodiments, a cryptographic management service 132 may store seeds or other information that may be used to generate keys, signatures, tokens, or other unique identifiers. Various other cryptographic or security measures can be implemented as well within the scope of the various embodiments. Such an approach provides multiple layers of security, as a secured set of parameters may only be able to be used by an authorized user with the proper private key, within an authorized environment, and the key and unencrypted parameters will be stored in a secure location that is inaccessible to unauthorized users, if even accessible to an authorized user other than as applied to the appropriate model. In at least one embodiment, an authorized inferencing environment can include, or work with, a cryptography verification service, provider, or module that is able to verify that a user has a correct and valid key before decrypting the parameters and allowing access, and can perform verification for subsequent inferencing requests as well, such that if the user no longer has a valid key then the user will no longer be able to use the optimized parameters, and in some embodiments may instead have to use a default or non-optimized parameter set. In some embodiments, the model itself may be an open source or publicly-accessible model, but a model provider or other entity may train an instance of that model on specific data in a specific way to generate a proprietary parameter set, and a user can obtain access to use the proprietary data set with the publicly-accessible model, as long as the corresponding conditions are met as discussed herein.

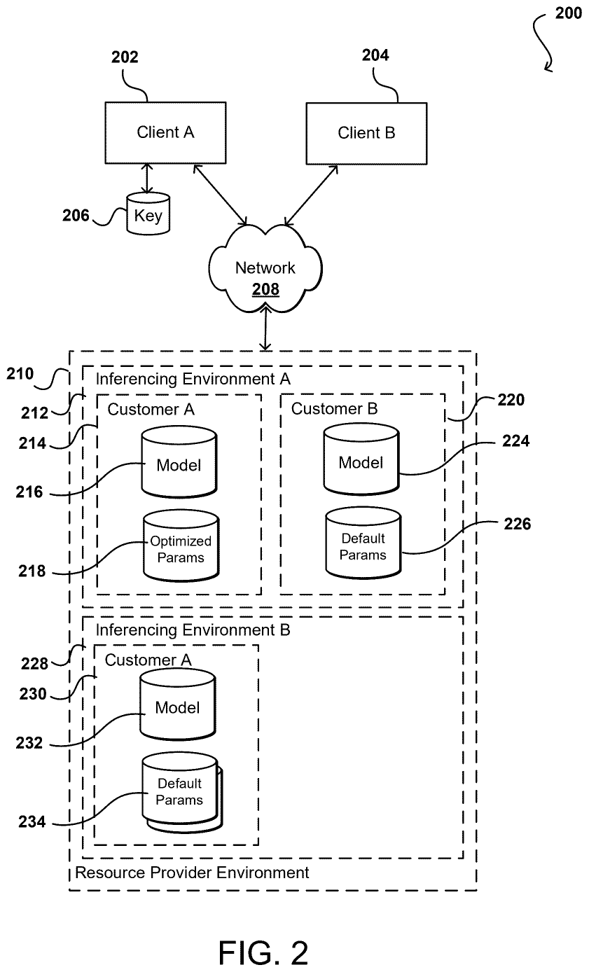

FIG. 2 illustrates a subset of components 200 of an example model management system, according to at least one embodiment. In this example, there are two client devices 202, 204 each associated with a different user. A first user A is associated with client A 202, which stores a local instance of a private key 206 used to encrypt a set of optimized parameters 218. A second user B is associated with client B 204, which does not have access to the private key. In this example, both users request use of a specific model to be used in inferencing environment A 212 hosted within a resource provider environment 210. In this example, customer A has a dedicated environment 214 within inferencing environment A 212, and customer B has a separate dedicated environment 220 within inferencing environment A 212. The client devices 202, 204 can access these environments over at least one network 208m such as the Internet, a local area network, or a cellular network, among other such options. As illustrated, a first instance of the model 216 is hosted in the customer A environment 214, while a second instance of the model 224 is hosted in the customer B environment 220. In this example, customer A has access to an optimized set of parameters 218, as a result of having an instance of the private key 206 needed to decrypt the parameter set. This can be a result of customer A obtaining a higher level of access, or optimized access, with respect to that which was obtained by customer B. Since customer B does not have the private key, the optimized parameters are unable to be decrypted in the customer B environment, such that the model 224 in customer environment B will instead use the default set of parameters 226. In this example, the model in the customer A environment 214 is able to use the optimized set of parameters 218 because customer A has access to the private key 206, and the model is hosted in an approved inferencing environment A 212. Even though the model 224 for customer B is also hosted in the approved inferencing environment A 212, the model 224 is unable to use the optimized parameters 218 because customer B does not have access to the respective private key.

Similarly, customer A hosts another instance of the same model 323 in another environment 230 that is specific to customer A. Customer A has access to the private key, and could decrypt the set of optimized parameters 218, but in this instance the model is hosted in a different inferencing environment B 228 that is not approved for use of the optimized parameters. Accordingly, the model 232 for customer A in inferencing environment B 228 will be limited to using the default parameters 234 for that model 232 as provided by the model provider. The determination of which parameters to use can be made dynamically and automatically, based in part upon the inferencing environment and access to the private key or other respective cryptographic information. Any appropriate approach can be used to demonstrate that a user has the private key or other cryptographic information, such as by generating a signature or hash value using the private key that can be independently verified, such as by the cryptographic management service 132 discussed with respect to FIG. 1.

In another embodiment, inferencing environment B 228 might also support use of the optimized parameters, but customer A might specify to only use the default parameters in inferencing environment B. Using a non-optimized set of parameters may come at a cheaper cost per inference, which may be desirable for less critical operations. Further, customer A may want to be able to direct critical requests to be processed using the optimized model in inferencing environment A 214, and direct less critical requests to be processed using the non-optimized model in inferencing environment B, which can help reduce cost and latency in some instances, among other such advantages.

As illustrated, customer A might also store multiple sets of parameters 234 in a given environment 230. In this way, the customer may be able to dynamically apply and/or use the parameters as appropriate for a given inferencing operation. For example, users associated with customer A might ask for classification requests on different types of objects, corresponding to different data domains, and there might be different parameter sets that perform better for those different domains. A customer may be able to obtain multiple different parameter sets that can be used as appropriate for specific inferencing requests. Similarly, a customer may be able to host multiple different models in the same environment, including differently optimized versions of the same model, and the model can be used can be determined for each individual request.

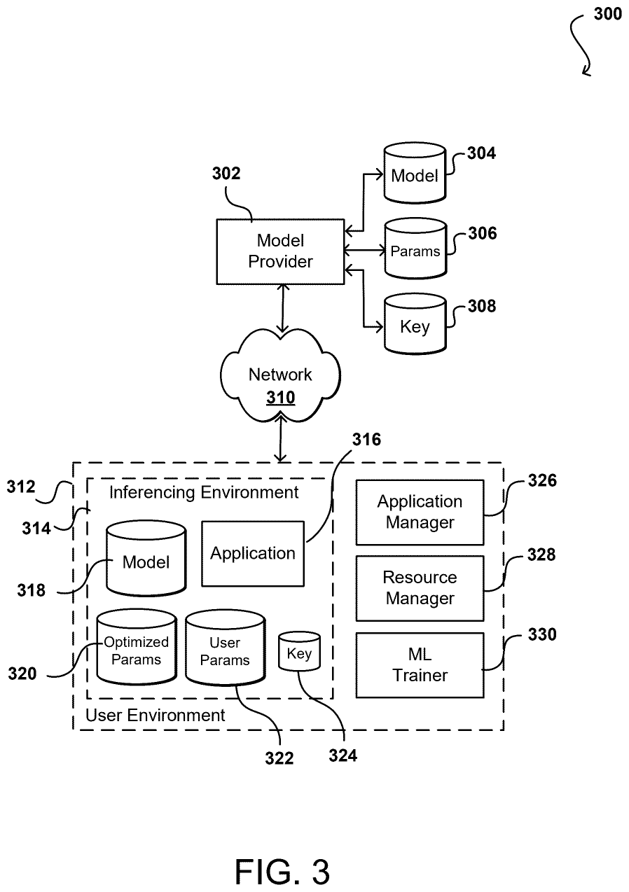

In some instances, a user may want to obtain optimized parameters and an optimized model that the user can use right away, but may wish to then refine or adjust the parameters based on additional user-identified (or otherwise user-provided or obtained) training data. FIG. 3 illustrates an example system 300 that can be used to further fine-tune parameters in accordance with at least one embodiment. In this example, a user may host an inferencing environment 314 on-prem, using user-provided resources in a user environment 312. The user can obtain a model 318 from a model provider system 302, which can provide the appropriate model from a model repository 304, and parameters from a parameter repository 306 as discussed previously. The user may also obtain a private key 324 that matches an asymmetric key pair associated with the model provider and stored in a secure key repository 308. As mentioned, having the key 324 enables the model 318 to run with optimized parameters 320 that were determined to be appropriate for one or more operations to be performed in the user environment 312, where the optimized parameters 320 can be transmitted by the model provider system 302 over at least one network 310 near the time of transmission of the model if the user has the key and is operating the model in an authorized inferencing environment 314. In some embodiments the optimized parameters 320 might be transmitted at other times, such as after the user obtains the key 324 or runs the model in an authorized inferencing environment 314. Optimized parameters might be received at other times as well, such as after a user changes an account with the model provider or changes the type of operation to be performed, among other such options. As mentioned elsewhere herein, different optimized parameters may be received at different times to be used with the same model as the conditions leading to that selection change, or as new optimized parameters are made available, or at other such times.

As mentioned, having the key 324 in various embodiments allows an optimized parameter set 320 (or other proprietary or secured parameter set) to be decrypted and used with a corresponding model 318 in an authorized inferencing environment 314. While the optimized parameters 320 will then be available for use with the model 318, the user (or another party having access to the inferencing environment 314) will not be able to access the individual parameters. The model and parameters can be stored in such a way in the inferencing environment as to allow for their use but protect access, such as by being stored using a secure module or hardware. This ability to protect the parameters is one factor that enables an inferencing environment 314, such as SageMaker, to be authorized to decrypt and use the optimized parameters should the associated user (or other such entity) have access to the corresponding cryptographic content. Such an approach allows the model 318 to be used for inferencing right away using the optimized parameters 320, without any need to train or optimize the model before use.

It may be the case, however, that a given user may wish to further optimize these parameters for use with the model 318 within the inferencing environment 314 hosted by the user. As an example, a user might have a training data set that is highly specific to the operations to be performed by the user, and even though the optimized parameters are already optimized, inferencing results for the user may be improved by further training or fine-tuning the model using user training data set. While the user may not have access to the optimized parameters, a training manager 330 (or optimization manager, etc.) can further train the model 318 starting from these optimized parameters. Although not illustrated in the figure, in some embodiments the training may need to be performed in an authorized training environment on behalf of a user with the appropriate key 324, as with use for inferencing, in order to access the optimized parameters. The trainer can use user-specific training data to fine-tune (or further optimize) the model 318 to produce a set of user-specific parameters 322. These user-specific parameters started from the optimized parameters 320 but were then fine-tuned. The user may still not be able to have access to the user-specific parameters, as they were derived from the optimized parameters and are still securely stored in the inferencing environment 314. The user can use the user parameters 322 with the model to perform inferencing in the inferencing environment 314. In at least some instances, the user will not want the user parameters to be shared outside the user environment 312. Accordingly, the inferencing environment can be configured to prevent transmission or access to the user parameters outside the user environment, which can also prevent the model provider system 302 from having access to the user parameters. The user may also optimize the model 318, such as to perform pruning or other such operations, which can result in not only a different model (or version of the model 318) but also a different user parameter set. The user-optimized model can also be prevented from being transmitted outside the user environment 312. In at least one embodiment, an application manager 326 may request a new optimized parameter set from the model provider system 302 if a new application requires a different type of inferencing operation to be performed, or if the operation performed for an existing inferencing application 316 changes. If a model 318 is added or optimized in the inferencing environment 314, a resource manager 328 can also modify the resources, or resource capacity, allocated to the inferencing environment, which can help to avoid retaining more resource capacity than needed if a model is reduced in size, for example, which can then require less resource capacity to train, host, and/or use. In some embodiments, a secure mechanism can be used to instead provide the user-specific data to a model provider for fine-tuning, where the model provider can perform the fine-tuning without having access to the user data outside the training environment, and the provider can provide back a secured user-specific training set that can be accessed by only the user with the appropriate key inside an authorized inferencing environment. In at least one embodiment, a user may further protect their user-specific parameters with an additional key or encryption/security mechanism.

Approaches discussed herein can help to increase the speed of loading a model into memory and getting the model parameters optimized to perform a specific type of inferencing. If there is an optimized model and parameter set already offered by a model provider, a user can quickly obtain the optimized model and parameter set to perform specific tasks. Optimizations can involve operations such as model sharding or specular decoding, among others. A user can obtain a key that allows the user to access the optimized parameter set, and can load the parameter set into an authorized environment (e.g., an authorized software container, virtual private cloud, or other managed offering from a vendor authorized by the model provider) for fast inferencing. In at least one embodiment, an invokable endpoint can be provided for use by a user, where the endpoint functions as a virtual entity on top of a set of resources (e.g., compute instances) running a model. A model provider can perform tasks such as model scaling, provisioning, and optimization, and can provide the appropriate model and parameters for use by the user. The endpoint can be associated with an authorized environment, which can include tools to not only secure the model and optimized parameters as appropriate, but also monitor usage of those parameters for inferencing in order to ensure such usage complies with the contractual term of usage, determine appropriate resource capacity, determine compensation due, and other such tasks. As mentioned, multiple models can be deployed to the same inferencing environment, with potentially multiple parameter sets for any of those given models, and the authorized environment can include tools for managing and securing these various models and parameter sets. In some embodiments a user may specify which model and/or parameter set to use for a given inferencing task, while in other embodiments an inferencing manager may make that decision automatically and dynamically based in part upon aspects or data for the inferencing task to be performed.

Another advantage of approaches disclosed herein is that there is no need for a third party to be involved in the model selection, optimization, and usage determination. For example, a user might work with a model provider to obtain an optimized model and parameter set, which the user intends to host on a cloud provider service, such as Amazon Web Services (AWS). In prior approaches the model provider might have had to work with AWS to ensure proper use, security, access, and other such factors. In various embodiments disclosed herein, the model provider can work directly with the user. As long as the user uses an authorized environment, even if the environment is hosted using AWS resources there is no need for the model provider to work with AWS, as the necessary security and management can be provided through that authorized environment (e.g., SageMaker). The model provider can provide the user with the appropriate key or cryptographic content, and can provide the model and encrypted parameters that can only be accessed by a user with the key in the authorized environment. In this way, the cloud provider can provide resources used to host the inferencing resources, but does not have access the optimized parameters and does not even need to be involved in the transaction. Approaches disclosed herein allow for proprietary models to be shared publicly, such as to be hosted by a cloud provider or distributed across the Internet, but prevent the usage of such models by unauthorized users or outside authorized environments. In some embodiments, an unauthorized user may be able to use the model with a default set of parameters, as may have been generated using a publicly-available training set for a general purpose, but will not be able to use the optimized parameters without at least the appropriate cryptographic content (e.g., private key).

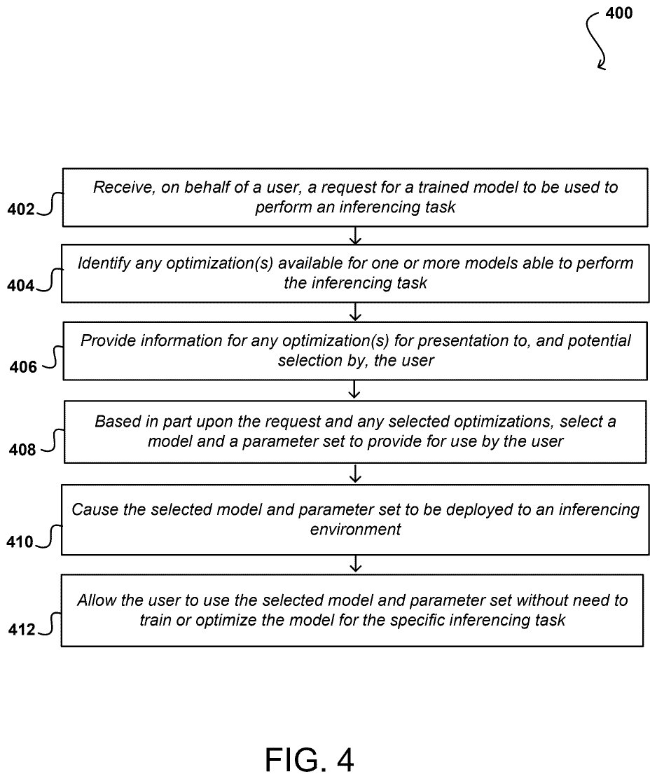

FIG. 4 illustrates an example process 400 that can be performed to automatically deploy an optimized model for inferencing, in accordance with at least one embodiment. It should be understood for this and other processes discussed and suggested herein that there can be additional, fewer, or alternative steps performed in similar or alternative orders, or at least partially in parallel, within the scope of the various embodiments unless otherwise specifically stated. In this example, a request is received 402, on behalf of a user, for a trained AI model to be used to perform at least one type of inferencing task. This request may be received by a model provider, for example, who might store a variety of models, as well as different sets of parameters for those models that were trained for different inferencing tasks or different data domains, among other such options. The model provider in this example can identify 404 one or more models that can perform the inferencing task (such as one or more classifiers that could perform a classification task), as well as any optimizations available for the identified model(s). For example, if classification is to be performed with respect to a specific data domain, such as for classifying animals versus warehouse inventory, then the model provider might be able to identify a set of parameters that were generated through fine-tuning a given model on an animal (or similar) data domain. If any such optimization is identified, information for the optimization(s) can be provided 406 for presentation to a user, who can have the ability to select one or more of those optimizations. In at least some embodiments, a user may have to comply with certain requirements or agree to provide a respective amount of compensation for each such optimization. Based in part upon the initial request and any relevant and available optimization(s) selected by the user, a model and parameter set can be selected 408 to provide for use by, or on behalf of, the user. This may include a base model and default parameter set, or may include an optimized or custom model with an optimized parameter set, or may include a base model with an optimized parameter set, among other such options or combinations. The selected model and parameter set can be caused 410 to be deployed to an identified inferencing environment. The user (or any other user, device, or application associated with the user) can then be allowed 412 to use the selected model and parameter set without need to train or optimize the model for a specific inferencing task. As an example, if a user requests to use a model to perform inferencing to classify images of animals, then the user may receive a default model and default set of parameters unless the user selects an optimization, and complies with the rules for using that optimization. If the user selected at least one optimization (or such an optimization was otherwise selected or indicated), and a request qualifies for use of that optimization, then a user can quickly be able to perform inferencing using a model and parameter set that were optimized for classifying images of animals, for example, without the need to further train or optimize the default model, which could otherwise be quite costly and complex for most users.

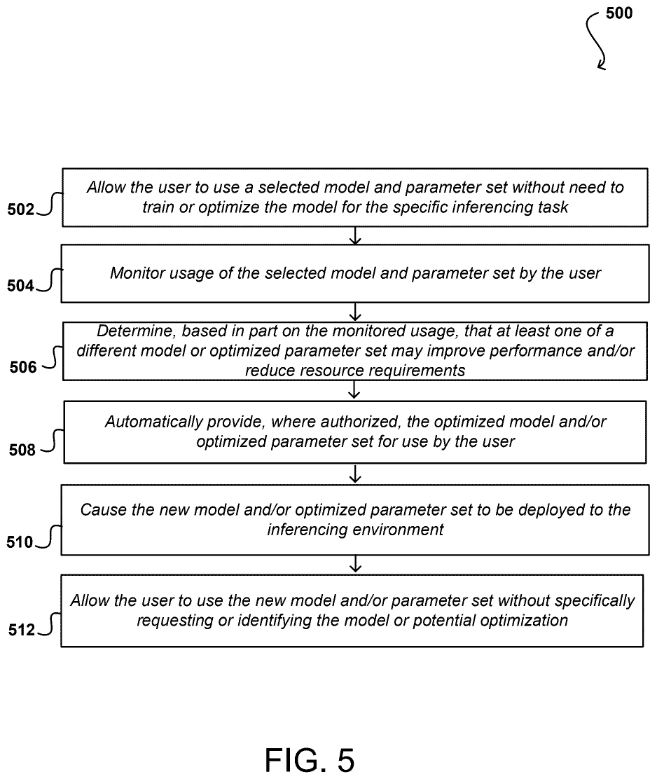

FIG. 5 illustrates an example process 500 that can be performed to automatically update or optimize a model and/or parameter set for a user, according to at least one embodiment. In this example process 500, a user is allowed 502 to use a selected model and parameter set to perform a specific inferencing task without the need to perform any fine-tuning or optimization of the model or parameters, such as discussed above with respect to the process 400 of FIG. 4. The model and parameters may be hosted in an inferencing environment, which may include a usage monitor that is able to monitor 504 usage of the selected model and parameter set by the user (or an entity, device, or process associated with the user). It can be determined 506, based in part on the monitored usage, that a different model and/or different parameter set may improve performance and/or reduce resource requirements. For example, a user may have received a parameter set that was directed to a general data domain, but it can be observed that all inferencing performed by the user is with respect to a specific data domain, which is a subset of the general data domain. If there is a parameter set optimized for that specific data domain, or if a parameter set can be generated that is optimized for that specific data domain, then the optimized set of parameters can be automatically provided 508 for use by the user, at last when the optimized set is available and it is determined that the user satisfies all appropriate criteria for use of the optimized training set. In some instances, the user might be notified of the availability of such an optimized set and allowed to select use of that set. It may also be determined that a different model might provide improved performance, such as a lightweight version of a classifier that has been pruned to have fewer parameters and thus can require less resource capacity to host and use, or that there is a different model that performs the same type of inferencing that may provide higher speed or accuracy. In some embodiments, a user may be able to specify certain optimization criteria to be used, while in other embodiments attempts can be made to generally optimize the model and/or parameters as appropriate, and as permitted to be available for use by, or on behalf of, that user. The new model and/or parameter set can be caused 510 to be automatically deployed to the inferencing environment. The user can then be allowed 512 to use the new model and/or parameter set for one or more inferencing tasks without specifically requesting or identifying the model, parameter set, or optimization, or potentially even being aware that a change was made to the model or parameters. Optimizations, customizations, or improvements can be applied automatically if allowed, as long as the user meets any criteria for use of those optimizations, customizations, or improvements.

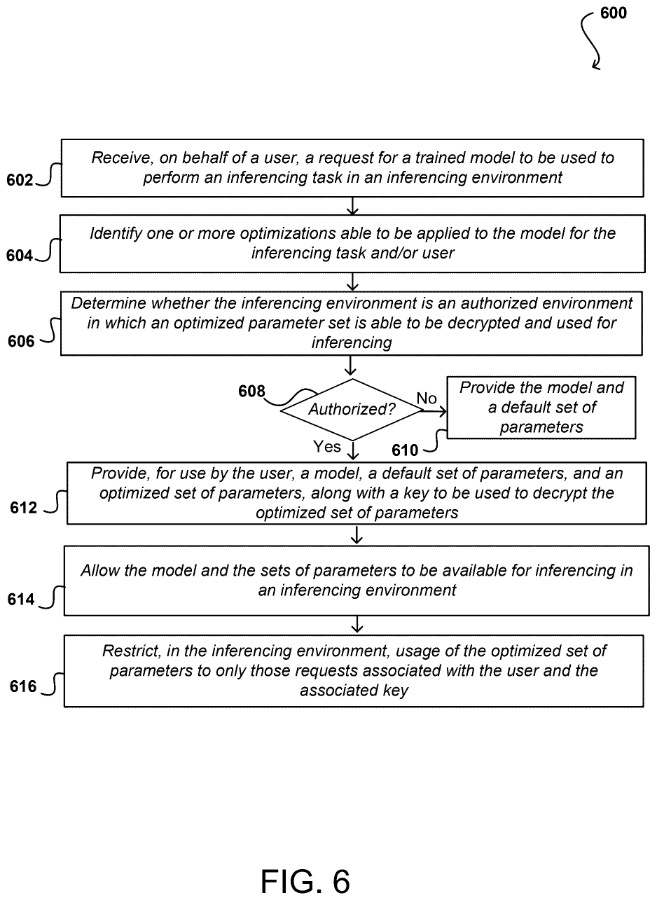

FIG. 6 illustrates another example process 600 that can be performed to ensure security of proprietary parameter sets, according to at least one embodiment. In this example process 600, a request for a trained model is received 602 on behalf of a user. The request is for a trained model to be provided that can be used to perform at least one type of inferencing task in an inferencing environment. In at least one embodiment, the request may include information (such as in metadata) indicating the type of inferencing environment, or inferencing platform or service used to provide that environment. The request can be received to an entity such as a model provider, which can provide a model and appropriate parameter set(s) to be used to perform the type of inferencing task. In this example, the model provider is able to identify 604 one or more optimizations that are able to be applied to the model for the inferencing task and/or user. Before applying or providing such optimizations, it can be determined 606 whether the inferencing environment is an authorized environment in which a given optimization (e.g., an optimized parameter set) is able and/or allowed to be decrypted and used for inferencing. As discussed herein, a model provider might only approve usage of an optimized parameter set in those inferencing environments in which secure management, storage, monitoring, and other such tasks or functions are guaranteed. If it is determined 608 that the inferencing environment is not one of these authorized inferencing environments, then the model (or a base version of the model) and a default set of parameters can be provided 610 for inferencing. In some embodiments the encrypted and optimized parameter set may be provided anyway, but in this example the optimized parameters even if decrypted are not provided to environments other than those approved environments for greater security.

If the inferencing environment is an authorized environment, and the user is authorized to use an optimized parameter set, for example, then the model provider (or other entity or source) can provide 612 a selected model, a default set of parameters, and an optimized set of parameters. The model provider can also cause a key (or other cryptographic token, etc.) to be provided to the user to allow the user to decrypt and use the optimized parameter set. As mentioned, the optimized parameter set may be encrypted using an asymmetric key pair, and the user needs to have a valid instance of the corresponding private key to decrypt the optimized parameter set, where such decryption is only allowed within an authorized inferencing environment. The model and the parameter sets can then be allowed 614 to be available for inferencing in the inferencing environment. Usage of the optimized set of parameters, however, can be restricted 616 to only those requests in the authorized inferencing environment that are associated with the user and the associated and valid key.

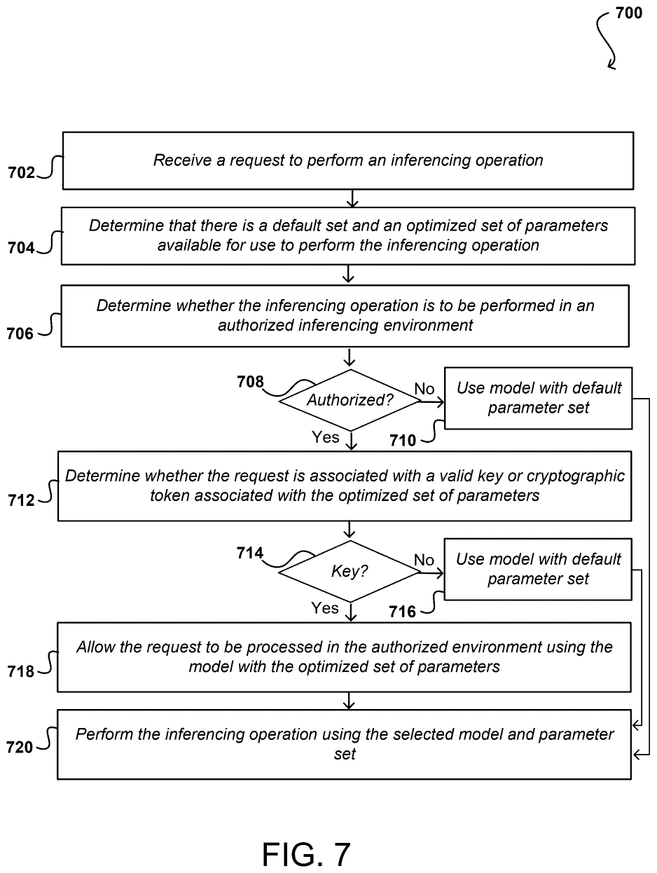

FIG. 7 illustrates an example process 700 that can be performed to automatically select a model and parameter set to use for an inferencing task, according to at least one embodiment. This can be performed in an inferencing environment where there may be one or more models and one or more parameter sets that can be used for different users, requests, and/or inferencing tasks. In this example, a request is received 702 to perform an inferencing operation. This request can be received with respect to an inferencing environment and on behalf of a user in this example. It can be determined 704 that there are a default set of parameters and an optimized set of parameters available to be used to perform the inferencing operation. There can be at least two determinations made that impact which parameter set to use. In one such determination (which can be performed before, after, or concurrently with the other determination), it can be determined 706 whether the inferencing operation is to be performed in an authorized inferencing environment, such as one that has been authorized for use of the optimized parameters by a parameter or model provider. If it is determined to not be authorized 708, then the model can be used 710 with a default parameter set to perform the inferencing operation. If the inferencing environment is authorized 708, another determination can involve determining 712 whether the request is associated with a valid key, cryptographic token, or other such security element that is associated with the set of parameters. If it is determined 714 that the request is not associated with such a key or token, for example, then the model can be used 716 with a default parameter set to perform the inferencing operation. If the request is associated with such a valid key or token, then the request can be allowed 718 to be processed in the authorized inferencing environment using the selected model with the optimized set of parameters. The inferencing operation can then be performed 720 using that model and parameter set. As mentioned, if the user becomes no longer associated with such a valid key or token, then future inferencing operations may then be performed using the default set, or a different set of parameters.

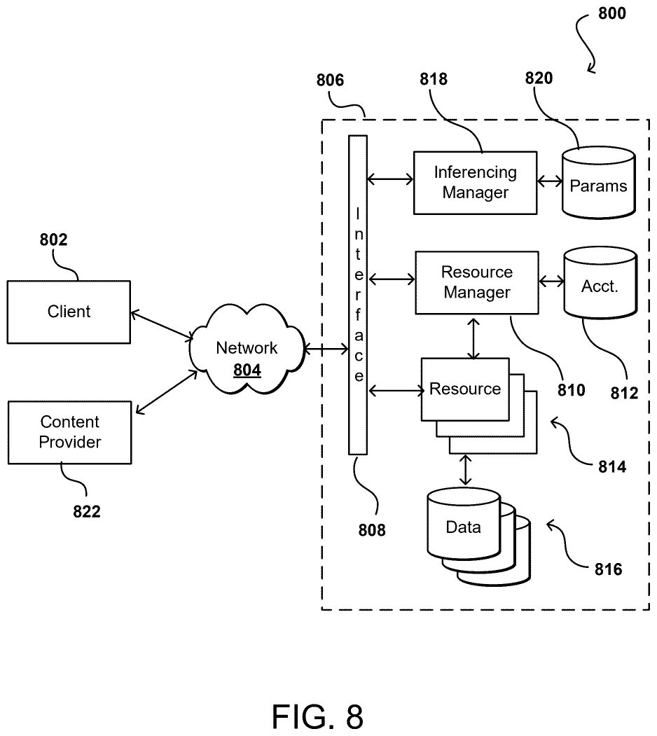

FIG. 8 illustrates an example environment 800 in which aspects of various embodiments can be implemented. Such an environment can be used in some embodiments to provide resource capacity for one or more users, or users of a resource provider, as part of a shared or multi-tenant resource environment. For example, the provider environment 806 can be a cloud environment that can be used to provide cloud-based network connectivity for users, as can be used during disaster recovery or network optimization. The resources can also provide networking functionality for one or more client devices 802, such as personal computers, which can be able to connect to one or more network(s) 804 or can be used to perform network optimization tasks as discussed herein.

In this example a user is able to utilize a client device 802 to submit requests across at least one network 804 to a multi-tenant resource provider environment 806. The client device can include any appropriate electronic device operable to send and receive requests, messages, or other such information over an appropriate network and convey information back to a user of the device. Examples of such client devices include personal computers, tablet computers, smartphones, notebook computers, and the like. The at least one network 804 can include any appropriate network, including an intranet, the Internet, a cellular network, a local area network (LAN), or any other such network or combination, and communication over the network can be enabled via wired and/or wireless connections. The resource provider environment 806 can include any appropriate components for receiving requests and returning information or performing actions in response to those requests. As an example, the provider environment might include Web servers and/or application servers for receiving and processing requests, then returning data, Web pages, video, audio, or other such content or information in response to the request. The environment can be secured such that only authorized users have permission to access those resources.

In various embodiments, a provider environment 806 can include various types of resources that can be utilized by multiple users for a variety of different purposes. As used herein, computing and other electronic resources utilized in a network environment can be referred to as “network resources.” These can include, for example, servers, databases, load balancers, routers, and the like, which can perform tasks such as to receive, transmit, and/or process data and/or executable instructions. In at least some embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In this example the provider environment includes a plurality of resources 814 of one or more types. These types can include, for example, application servers operable to process instructions provided by a user or database servers operable to process data stored in one or more data stores 816 in response to a user request. As known for such purposes, a user can also reserve at least a portion of the data storage in a given data store. Methods for enabling a user to reserve various resources and resource instances are well known in the art, such that detailed description of the entire process, and explanation of all possible components, will not be discussed in detail herein.

In at least some embodiments, a user wanting to utilize a portion of the resources 814 can submit a request that is received to an interface layer 808 of the provider environment 806. The interface layer can include application programming interfaces (APIs) or other exposed interfaces enabling a user to submit requests to the provider environment. The interface layer 808 in this example can also include other components as well, such as at least one Web server, routing components, load balancers, and the like. When a request to provision a resource is received to the interface layer 808, information for the request can be directed to a resource manager 810 or other such system, service, or component configured to manage user accounts and information, resource provisioning and usage, and other such aspects. A resource manager 810 receiving the request can perform tasks such as to authenticate an identity of the user submitting the request, as well as to determine whether that user has an existing account with the resource provider, where the account data can be stored in at least one data store 812 in the provider environment. A user can provide any of various types of credentials in order to authenticate an identity of the user to the provider. These credentials can include, for example, a username and password pair, biometric data, a digital signature, a secure token, or other such information. The provider can validate this information against information stored for the user. If a user has an account with the appropriate permissions, status, etc., the resource manager can determine whether there are adequate resources available to suit the user's request, and if so can provision the resources or otherwise grant access to the corresponding portion of those resources for use by the user for an amount specified by the request. This amount can include, for example, capacity to process a single request or perform a single task, a specified period of time, or a recurring/renewable period, among other such values. If the user does not have a valid account with the provider, the user account does not enable access to the type of resources specified in the request, or another such reason is preventing the user from obtaining access to such resources, a communication can be sent to the user to enable the user to create or modify an account, or change the resources specified in the request, among other such options.

Once a user (or other requestor) is authenticated, the account verified, and the resources allocated, the user can utilize the allocated resource(s) for the specified capacity, amount of data transfer, period of time, or other such value. In at least some embodiments, a user might provide a session token or other such credentials with subsequent requests in order to enable those requests to be processed on that user session. The user can receive a resource identity, specific address, or other such information that can enable the client device 802 to communicate with an allocated resource without having to communicate with the resource manager 810, at least until such time as a relevant aspect of the user account changes, the user is no longer granted access to the resource, or another such aspect changes. In some embodiments, a user can run a host operating system on a physical resource, such as a server, which can provide that user with direct access to hardware and software on that server, providing near full access and control over that resource for at least a determined period of time. Access such as this is sometimes referred to as “bare metal” access as a user provisioned on that resource has access to the physical hardware.

A resource manager 810 (or another such system or service) in this example can also function as a virtual layer of hardware and software components that handles control functions in addition to management actions, as can include provisioning, scaling, replication, etc. The resource manager can utilize dedicated APIs in the interface layer 808, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer 808 in at least one embodiment includes a scalable set of user-facing servers that can provide the various APIs and return the appropriate responses based on the API specifications. The interface layer also can include at least one API service layer that in one embodiment consists of stateless, replicated servers which process the externally-facing user APIs. The interface layer can be responsible for Web service front end features such as authenticating users based on credentials, authorizing the user, throttling user requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, users of the control service. The servers of the Web services layer can be stateless and scaled horizontally as known in the art. API servers, as well as the persistent data store, can be spread across multiple data centers in a region, for example, such that the servers are resilient to single data center failures.

In at least one embodiment, inferencing tasks may be performed using the allocated resources 814. In this example, an inferencing manager 818 may provide an inferencing environment, and may work with one or more model, parameter, or other content providers 822 to obtain models and parameter sets to be used to perform inferencing tasks in the inferencing environment. As disclosed herein, an inferencing manager may store multiple sets of parameters, such as in a parameter repository 820, and then determine which parameter set to use with a model to perform an inferencing operation, as may depend at least in part on the type of inferencing task and the permission of the user, as may be demonstrated by possession of a valid key or security token, among other such options.

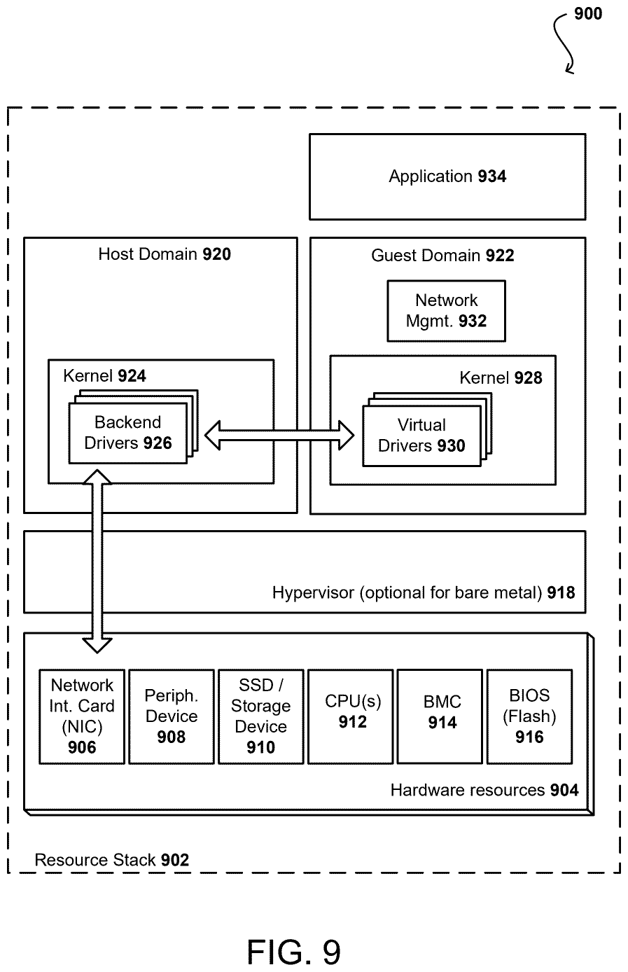

FIG. 9 illustrates an example resource stack 902 of a physical resource 900 that can be utilized in accordance with various embodiments, such as can be provided as part of a provider environment such as that illustrated in FIG. 8. Such a resource can be used as a network router, for example, which can be selected as a waypoint for determining a secondary transmission path or selected as part of a primary transmission path, among other such options. When performing tasks, such as network routing tasks using a routing application or service, for example, such resources can include components such as CPUs 912 for executing code to perform these tasks, NICs 906 for communicating network traffic, and memory for storing instructions and networking data. In some embodiments, an entire machine can be allocated for these tasks, or only a portion of the machine, such as to allocate a portion of the resources as a virtual machine in a guest domain 922 that can perform at least some of these tasks.

Such a resource stack 902 can be used to provide an allocated environment for a user (or user of a resource provider) having an operating system provisioned on the resource. In accordance with the illustrated embodiment, the resource stack 902 includes a number of hardware resources 904, such as one or more central processing units (CPUs) 912; solid state drives (SSDs) or other storage devices 910; a network interface card (NIC) 906, one or more peripheral devices (e.g., a graphics processing unit (GPU), etc.) 908, a BIOS implemented in flash memory 916, and a Board Management Controller (BMC) 914, and the like. In some embodiments, the hardware resources 904 reside on a single computing device (e.g. chassis). In other embodiments, the hardware resources can reside on multiple devices, racks, chassis, and the like. Running on top of the hardware resources 904, a virtual resource stack can include a virtualization layer such as a hypervisor 918 for a Xen-based implementation, a host domain 920, and potentially also one or more guest domains 922 capable of executing at least one application 934. The hypervisor 918, if utilized for a virtualized environment, can manage execution of the one or more guest operating systems and allow multiple instances of different operating systems to share the underlying hardware resources 904. Conventionally, hypervisors are installed on server hardware, with the function of running guest operating systems, where the guest operating systems themselves act as servers.

In accordance with an embodiment, a hypervisor 918 can host a number of domains (e.g., virtual machines), such as the host domain 920 and one or more guest domains 922. In one embodiment, the host domain 920 (e.g., the Dom-0) is the first domain created and helps virtualize hardware resources and manage all of the other domains running on the hypervisor 918. For example, the host domain 920 can manage the creating, destroying, migrating, saving, or restoring the one or more guest domains 922 (e.g., the Dom-U). In accordance with various embodiments, the hypervisor 918 can control access to the hardware resources such as the CPU, input/output (I/O) memory, and hypervisor memory. A guest domain 922 may contain its own network management module 932 in at least some embodiments.

A guest domain 922 can include one or more virtualized or para-virtualized drivers 930 and the host domain can include one or more backend device drivers 926. When the operating system (OS) kernel 928 in the guest domain 922 wants to invoke an I/O operation, the virtualized driver 930 can perform the operation by way of communicating with the backend device driver 926 in the host domain 920. When the virtualized driver 930 wants to initiate an I/O operation (e.g., to send out a network packet), a guest kernel component can identify which physical memory buffer contains the packet (or other data) and the virtualized driver 930 can either copy the memory buffer to a temporary storage location in the kernel for performing I/O or obtain a set of pointers to the memory pages that contain the packet(s). In at least one embodiment, these locations or pointers are provided to the backend driver 926 of the host kernel 924 which can obtain access to the data and communicate it directly to the hardware device, such as the NIC 906 for sending the packet over the network.

It should be noted that the resource stack 902 illustrated in FIG. 9 is only one possible example of a set of resources that is capable of providing a virtualized computing environment and that the various embodiments described herein are not necessarily limited to this particular resource stack. In some embodiments, the guest domain 922 can have substantially native or “bare metal” access to the NIC 906 hardware, for example as provided by device assignment technology based on an IO Memory Management Unit (IO-MMU) device mapping solution like Intel VT-D. In such an implementation, there can be no virtualization layer (e.g., Hypervisor) present. The host domain, or OS, can then be provided by the user, with no guest domains utilized. Other technologies, such Single Root IO Virtualization (SR-IOV), can provide similar “bare metal” functionality to guest domains for only certain functionality of the devices. In general, in various other embodiments, the resource stack can comprise different virtualization strategies, hardware devices, operating systems, kernels, domains, drivers, hypervisors and other resources.

In compute servers, a Board Management Controller (BMC) 914 can maintain a list of events that have occurred in the system, referred to herein as a system event log (SEL). In at least one embodiment, the BMC 914 can receive system event logs from the BIOS 916 on the host processor. The BIOS 916 can provide data for system events over an appropriate interface, such as an I2C interface, to the BMC using an appropriate protocol, such as an SMBus System Interface (SSIF) or KCS interface over LPC. As mentioned, an example of a system event log event from BIOS includes an uncorrectable memory error, indicating a bad RAM stick. In at least some embodiments, system event logs recorded by BMCs on various resources can be used for purposes such as to monitor server health, including triggering manual replacement of parts or instance degrade when SELs from the BIOS indicate failure.

As mentioned, in a virtualized environment the hypervisor 918 can prevent the guest operating system, or guest domain 922, from sending such system event log data to the BMC 914. In the case of bare metal access without such a hypervisor, however, user instances can have the ability to send data for system events that spoof events from the BIOS 916. Such activity could lead to compromised bare metal instances being prematurely degraded due to fake system event data produced by the user OS.

In at least one embodiment, however, there will be portions of the physical resource 900 that will be inaccessible to the user OS. This can include, for example, at least a portion of BIOS memory 916. BIOS memory 916 in at least one embodiment is volatile memory such that any data stored in that memory will be lost in the event of a reboot or power down event. The BIOS can keep at least a portion of host memory unmapped, such that it is not discoverable by a host OS. As mentioned, data such as a secret token can be stored to BIOS memory 916 at boot time, before a user OS is executing on the resource. Once the user OS is executing on the resource, that OS will be prevented from accessing that secret token in BIOS memory 916. In at least one embodiment, this secret token (or other stored secret) can be provided to the BMC 914 when adding system event log events, whereby the BMC 914 can confirm that the event is being sent by the BIOS 916 and not by the user OS.

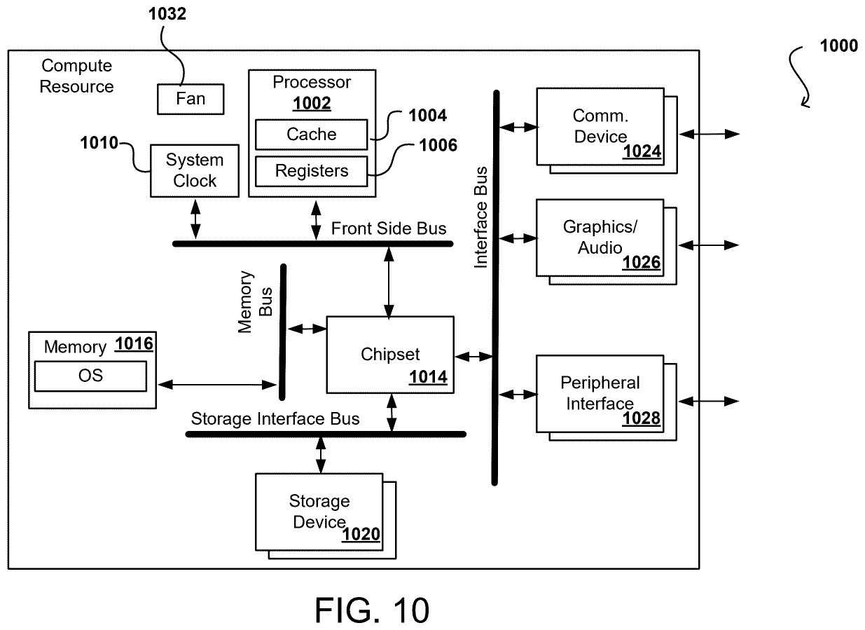

Computing resources, such as servers, routers, smartphones, or personal computers, will generally include at least a set of standard components configured for general purpose operation, although various proprietary components and configurations can be used as well within the scope of the various embodiments. As mentioned, this can include client devices for transmitting and receiving network communications, or servers for performing tasks such as network analysis and rerouting, among other such options. FIG. 10 illustrates components of an example computing resource 1000 that can be utilized in accordance with various embodiments. It should be understood that there can be many such compute resources and many such components provided in various arrangements, such as in a local network or across the Internet or “cloud,” to provide compute resource capacity as discussed elsewhere herein. The computing resource 1000 (e.g., a desktop or network server) will have one or more processors 1002, such as central processing units (CPUs), graphics processing units (GPUs), and the like, that are electronically and/or communicatively coupled with various components using various buses, traces, and other such mechanisms. A system clock 1010 may be used to provide a synchronizing reference signal to various components of the compute resource 1000. A processor 1002 can include memory registers 1006 and cache memory 1004 for holding instructions, data, and the like. In this example, a chipset 1014, which can include a northbridge and southbridge in some embodiments, can work with the various system buses to connect the processor 1002 to components such as memory 1016, in the form or physical RAM or ROM, which can include the code for the operating system as well as various other instructions and data utilized for operation of the computing device. The computing device can also contain, or communicate with, one or more storage devices 1020, such as hard drives, flash drives, optical storage, and the like, for persisting data and instructions similar, or in addition to, those stored in the processor and memory. The processor 1002 can also communicate with various other components via the chipset 1014 and an interface bus (or graphics bus, etc.), where those components can include communications devices 1024 such as cellular modems or network cards, media components 1026, such as graphics cards and audio components, and peripheral interfaces 1028 for connecting peripheral devices, such as printers, keyboards, and the like. At least one cooling fan 1032 or other such temperature regulating or reduction component can also be included as well, which can be driven by the processor or triggered by various other sensors or components on, or remote from, the device. Various other or alternative components and configurations can be utilized as well as known in the art for computing devices.

At least one processor 1002 can obtain data from physical memory 1016, such as a dynamic random access memory (DRAM) module, via a coherency fabric in some embodiments. It should be understood that various architectures can be utilized for such a computing device, which can include varying selections, numbers, and arguments of buses and bridges within the scope of the various embodiments. The data in memory can be managed and accessed by a memory controller, such as a DDR controller, through the coherency fabric. The data can be temporarily stored in a processor cache 1004 in at least some embodiments. The computing resource 1000 can also support multiple I/O devices using a set of I/O controllers connected via an I/O bus. There can be I/O controllers to support respective types of I/O devices, such as a universal serial bus (USB) device, data storage (e.g., flash or disk storage), a network card, a peripheral component interconnect express (PCIe) card or interface 1028, a communication device 1024, a graphics or audio card 1026, and a direct memory access (DMA) card, among other such options. In some embodiments, components such as the processor, controllers, and caches can be configured on a single card, board, or chip (i.e., a system-on-chip implementation), while in other embodiments at least some of the components can be located in different locations, etc.

An operating system (OS) running on the processor 1002 can help to manage the various devices that can be utilized to provide input to be processed. This can include, for example, utilizing relevant device drivers to enable interaction with various I/O devices, where those devices can relate to data storage, device communications, user interfaces, and the like. The various I/O devices will typically connect via various device ports and communicate with the processor and other device components over one or more buses. There can be specific types of buses that provide for communications according to specific protocols, as can include peripheral component interconnect) PCI or small computer system interface (SCSI) communications, among other such options. Communications can occur using registers associated with the respective ports, including registers such as data-in and data-out registers. Communications can also occur using memory-mapped I/O, where a portion of the address space of a processor is mapped to a specific device, and data is written directly to, and from, that portion of the address space.

Such a device can be used, for example, as a server in a server farm or data warehouse. Server computers often have a need to perform tasks outside the environment of the CPU and main memory (i.e., RAM). For example, the server can need to communicate with external entities (e.g., other servers) or process data using an external processor (e.g., a General Purpose Graphical Processing Unit (GPGPU)). In such cases, the CPU can interface with one or more I/O devices. In some cases, these I/O devices can be special-purpose hardware designed to perform a specific role. For example, an Ethernet network interface controller (NIC) can be implemented as an application-specific integrated circuit (ASIC) comprising digital logic operable to send and receive packets.

In an illustrative embodiment, a host computing device is associated with various hardware components, software components and respective configurations that facilitate the execution of I/O requests. One such component is an I/O adapter that inputs and/or outputs data along a communication channel. In one aspect, the I/O adapter device can communicate as a standard bridge component for facilitating access between various physical and emulated components and a communication channel. In another aspect, the I/O adapter device can include embedded microprocessors to allow the I/O adapter device to execute computer executable instructions related to the implementation of management functions or the management of one or more such management functions, or to execute other computer executable instructions related to the implementation of the I/O adapter device. In some embodiments, the I/O adapter device can be implemented using multiple discrete hardware elements, such as multiple cards or other devices. A management controller can be configured in such a way to be electrically isolated from any other component in the host device other than the I/O adapter device. In some embodiments, the I/O adapter device is attached externally to the host device. In some embodiments, the I/O adapter device is internally integrated into the host device. Also in communication with the I/O adapter device can be an external communication port component for establishing communication channels between the host device and one or more network-based services or other network-attached or direct-attached computing devices. Illustratively, the external communication port component can correspond to a network switch, sometimes known as a Top of Rack (“TOR”) switch. The I/O adapter device can utilize the external communication port component to maintain communication channels between one or more services and the host device, such as health check services, financial services, and the like.

The I/O adapter device can also be in communication with a Basic Input/Output System (BIOS) component. The BIOS component can include non-transitory executable code, often referred to as firmware, which can be executed by one or more processors and used to cause components of the host device to initialize and identify system devices such as the video display card, keyboard and mouse, hard disk drive, optical disk drive and other hardware. The BIOS component can also include or locate boot loader software that will be utilized to boot the host device. For example, in one embodiment, the BIOS component can include executable code that, when executed by a processor, causes the host device to attempt to locate Preboot Execution Environment (PXE) boot software. Additionally, the BIOS component can include or take the benefit of a hardware latch that is electrically controlled by the I/O adapter device. The hardware latch can restrict access to one or more aspects of the BIOS component, such as controlling modifications or configurations of the executable code maintained in the BIOS component. The BIOS component can be connected to (or in communication with) a number of additional computing device components, such as processors, memory, and the like. In one embodiment, such computing device resource components can be physical computing device resources in communication with other components via the communication channel. The communication channel can correspond to one or more communication buses, such as a shared bus (e.g., a front side bus, a memory bus), a point-to-point bus such as a PCI or PCI Express bus, etc., in which the components of the bare metal host device communicate. Other types of communication channels, communication media, communication buses or communication protocols (e.g., the Ethernet communication protocol) can also be utilized. Additionally, in other embodiments, one or more of the computing device resource components can be virtualized hardware components emulated by the host device. In such embodiments, the I/O adapter device can implement a management process in which a host device is configured with physical or emulated hardware components based on a variety of criteria. The computing device resource components can be in communication with the I/O adapter device via the communication channel. In addition, a communication channel can connect a PCI Express device to a CPU via a northbridge or host bridge, among other such options.

In communication with the I/O adapter device via the communication channel can be one or more controller components for managing hard drives or other forms of memory. An example of a controller component can be a SATA hard drive controller. Similar to the BIOS component, the controller components can include or take the benefit of a hardware latch that is electrically controlled by the I/O adapter device. The hardware latch can restrict access to one or more aspects of the controller component. Illustratively, the hardware latches can be controlled together or independently. For example, the I/O adapter device can selectively close a hardware latch for one or more components based on a trust level associated with a particular user. In another example, the I/O adapter device can selectively close a hardware latch for one or more components based on a trust level associated with an author or distributor of the executable code to be executed by the I/O adapter device. In a further example, the I/O adapter device can selectively close a hardware latch for one or more components based on a trust level associated with the component itself. The host device can also include additional components that are in communication with one or more of the illustrative components associated with the host device. Such components can include devices, such as one or more controllers in combination with one or more peripheral devices, such as hard disks or other storage devices. Additionally, the additional components of the host device can include another set of peripheral devices, such as Graphics Processing Units (“GPUs”). The peripheral devices and can also be associated with hardware latches for restricting access to one or more aspects of the component. As mentioned above, in one embodiment, the hardware latches can be controlled together or independently.

As discussed, different approaches can be implemented in various environments in accordance with the described embodiments. As will be appreciated, although a network-or Web-based environment is used for purposes of explanation in several examples presented herein, different environments can be used, as appropriate, to implement various embodiments. Such a system can include at least one electronic client device, which can include any appropriate device operable to send and receive requests, messages or information over an appropriate network and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server for receiving requests and serving content in response thereto, although for other networks, an alternative device serving a similar purpose could be used, as would be apparent to one of ordinary skill in the art.

The illustrative environment includes at least one application server and a data store. It should be understood that there can be several application servers, layers or other elements, processes or components, which can be chained or otherwise configured, which can interact to perform tasks such as obtaining data from an appropriate data store. As used herein, the term “data store” refers to any device or combination of devices capable of storing, accessing and retrieving data, which can include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which can be served to the user by the Web server in the form of HTML, XML or another appropriate structured language in this example. The handling of all requests and responses, as well as the delivery of content between the client device and the application server, can be handled by the Web server. It should be understood that the Web and application servers are not required and are merely example components, as structured code discussed herein can be executed on any appropriate device or host machine as discussed elsewhere herein.

The data store can include several separate data tables, databases or other data storage mechanisms and media for storing data relating to a particular aspect. For example, the data store illustrated includes mechanisms for storing content (e.g., production data) and user information, which can be used to serve content for the production side. The data store is also shown to include a mechanism for storing log or session data. It should be understood that there can be many other aspects that can need to be stored in the data store, such as page image information and access rights information, which can be stored in any of the above listed mechanisms as appropriate or in additional mechanisms in the data store. The data store is operable, through logic associated therewith, to receive instructions from the application server and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated. Thus, the depiction of the systems herein should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) can also be capable of executing programs or scripts in response requests from user devices, such as by executing one or more Web applications that can be implemented as one or more scripts or programs written in any programming language, such as Java®, C, C #or C++ or any scripting language, such as Perl, Python or TCL, as well as combinations thereof. The server(s) can also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers can include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information can reside in a storage-area network (SAN) familiar to those skilled in the art. Similarly, any necessary files for performing the functions attributed to the computers, servers or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system can also include one or more storage devices, such as disk drives, magnetic tape drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments can have numerous variations from that described above. For example, customized hardware might also be used and/or particular elements might be implemented in hardware, software (including portable software, such as applets) or both. Further, connection to other computing devices such as network input/output devices can be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes can be made thereunto without departing from the broader spirit and scope of the invention as set forth in the claims.

What is claimed is:

1. A computer-implemented method, comprising:
receiving, on behalf of a user, a request for an artificial intelligence (AI) model optimized to perform a type of inferencing task;
verifying that the AI model will be hosted in an authorized inferencing environment and that the user complies with one or more usage criteria;
providing, for deployment in the authorized inferencing environment, the AI model, a default set of model parameters, and an optimized set of model parameters, the optimized set encrypted using a cryptographic key;
providing the user with a decryption key to be used to decrypt the optimized set of model parameters;
decrypting, using the decryption key, the optimized set of model parameters in the authorized inferencing environment, the optimized set of model parameters once decrypted being securely stored in the authorized inferencing environment to prevent user access;
receiving, on behalf of the user, a request to perform an inferencing task of the type;
verifying that the inferencing task is to be performed in the authorized inferencing environment and that the user is associated with a valid instance of the decryption key; and
performing the inferencing task using the model with the optimized set of model parameters.

2. The computer-implemented method according to claim 1, further comprising:
receiving, on behalf of the user, a request to perform an inferencing task of the type;
determining that the user is not currently associated with a valid copy of the decryption key; and
performing the inferencing task using the model with the default set of model parameters.

3. The computer-implemented method according to claim 1, further comprising:
receiving, on behalf of the user, a request to perform an inferencing task of the type;
determining that the inferencing task is to be performed outside the authorized inferencing environment; and
performing the inferencing task using the model with the default set of model parameters.

4. The computer-implemented method according to claim 1, further comprising:
receiving, on behalf of a second user, a request to perform an inferencing task of the type;
determining that second user is not associated with a valid copy of the decryption key or the inferencing task is to be performed outside the authorized inferencing environment; and
performing the inferencing task using the model with the default set of model parameters.

5. The computer-implemented method according to claim 1, wherein the one or more usage criteria include at least operation in the authorized inferencing environment, having ability to automatically deploy optimizations, or agreement to provide additional compensation for use of one or more optimized sets of model parameters.

6. A computer-implemented method, comprising:
receiving a model trained to perform an inferencing task, a default set of model parameters, an optimized set of model parameters, and a cryptographic key to be used by an authorized user to decrypt and use the optimized set of model parameters;
deploying the model, the default set of model parameters, and the optimized set of model parameters to an authorized inferencing environment, the optimized set decrypted, on behalf of the authorized user, using the cryptographic key and securely stored in the authorized inferencing environment to prevent user access;
receiving, on behalf of the authorized user, a request to perform the inferencing task;
verifying that the inferencing task is to be performed in the authorized inferencing environment and that the authorized user is associated with a valid instance of the encryption key; and
performing, in the authorized inferencing environment, the inferencing task using the model with the optimized set of model parameters.

7. The computer-implemented method of claim 6, further comprising:
receiving, on behalf of the authorized user, a second request to perform a second occurrence of the inferencing task;
determining that the authorized user is not currently associated with a valid copy of the cryptographic key; and
performing the inferencing task using the model with the default set of model parameters.

8. The computer-implemented method according to claim 6, further comprising:
receiving, on behalf of the authorized user, a second request to perform a second occurrence of the inferencing task;
determining that the second occurrence is to be performed outside the authorized inferencing environment; and
performing the second occurrence of the inferencing task using the model with the default set of model parameters.

9. The computer-implemented method according to claim 6, further comprising:
receiving, on behalf of a second user, a request to perform the inferencing task;
determining that second user is not associated with a valid copy of the decryption key or the inferencing task is to be performed outside the authorized inferencing environment; and
performing the inferencing task using the model with the default set of model parameters.

10. The computer-implemented method according to claim 6, further comprising:
storing multiple optimized sets of parameters to the authorized inferencing environment, individual optimized sets optimized for different data domains or types of inferencing tasks; and
determining, in response to a request to perform the inferencing task in the authorized inferencing environment, an optimized set of parameters determined to be most relevant to the inferencing task.

11. The computer-implemented method of claim 6, further comprising:
monitoring usage of the model in the authorized inferencing environment;
identifying at least one additional or alternative optimization available to be applied to the model to improve performance of the inferencing task; and
automatically deploying the at least one additional or alternative optimization in the authorized inferencing environment to be available for use in performing the inferencing task.

12. The computer-implemented method of claim 11, wherein the at least one additional or alternative optimization includes an alternative version of the model optimized using at least one of quantization, distillation, pruning, model loading, or sharding.

13. The computer-implemented method of claim 6, wherein the cryptographic key is a private key of an asymmetric key pair used to encrypt the optimized set of parameters.

14. The computer-implemented method of claim 6, further comprising:
allowing the authorized user to further train the model, with the selected optimization applied, using user-provided training data.

15. The computer-implemented method of claim 6, further comprising:
receiving, from a model provider to a resource provider environment, the model, the default set of model parameters, and an encrypted version of the optimized set of model parameters; and
allowing the model and the default set of model parameters to be deployed for use outside the authorized inferencing environment; and
allowing the model, the default set of parameters, and the optimized set of model parameters to be deployed for use in the authorized inferencing environment, the optimized set of model parameters only being able to be decrypted in the authorized inferencing environment using a valid instance of the cryptographic key.

16. A system, comprising:
at least one processor; and
a memory device including instructions that, when executed by the processor, cause the processor to:
obtain a model trained to perform an inferencing task, a default set of model parameters, an optimized set of model parameters, and a cryptographic key to be used by an authorized user to decrypt and use the optimized set of model parameters;
deploy the model, the default set of model parameters, and the optimized set of model parameters to an authorized inferencing environment, the optimized set decrypted, on behalf of the authorized user, using the cryptographic key and securely stored in the authorized inferencing environment to prevent user access;
receive, on behalf of the authorized user, a request to perform the inferencing task;
verify that the inferencing task is to be performed in the authorized inferencing environment and that the authorized user is associated with a valid instance of the encryption key; and
perform, in the authorized inferencing environment, the inferencing task using the model with the optimized set of model parameters.

17. The system of claim 16, wherein the instructions, when executed by the at least one processor, further cause the at least one processor to:
receive, on behalf of the authorized user, a second request to perform a second occurrence of the inferencing task;
determine that the authorized user is not currently associated with a valid copy of the cryptographic key; and
perform the inferencing task using the model with the default set of model parameters.

18. The system of claim 16, wherein the instructions, when executed by the at least one processor, further cause the at least one processor to:
receive, on behalf of the authorized user, a second request to perform a second occurrence of the inferencing task;
determine that the second occurrence is to be performed outside the authorized inferencing environment; and
perform the second occurrence of the inferencing task using the model with the default set of model parameters.

19. The system of claim 16, wherein the instructions, when executed by the at least one processor, further cause the at least one processor to:
receive, on behalf of a second user, a request to perform the inferencing task;
determine that second user is not associated with a valid copy of the decryption key or the inferencing task is to be performed outside the authorized inferencing environment; and
perform the inferencing task using the model with the default set of model parameters.

20. The system of claim 16, wherein the instructions, when executed by the at least one processor, further cause the at least one processor to:
store multiple optimized sets of parameters to the authorized inferencing environment, individual optimized sets optimized for different data domains or types of inferencing tasks; and
determine, in response to a request to perform the inferencing task in the authorized inferencing environment, an optimized set of parameters determined to be most relevant to the inferencing task.
